(19) United States
(12) Patent Application Publication
(10) Pub. No.: US 2012/0062127 A1
(43) Pub. Date: Mar. 15, 2012

(54) LIGHT EMITTING DIODE LAMP AND OPTICAL COMMUNICATION NETWORKING SYSTEM

(75) Inventor: WEN-KUEI TSAI, Taipei (TW)

(73) Assignee: GE INVESTMENT CO., LTD., Taipei City (TW)

(21) Appl. No.: 13/232,708

(22) Filed: Sep. 14, 2011

(30) Foreign Application Priority Data
Sep. 14, 2010 (TW) 099131030

(51) Int. Cl. H05B 37/02

(52) U.S. Cl. 315/151; 315/152

(57) ABSTRACT

A light emitting diode (LED) lamp includes a lamp body, an LED array, a light driving unit and a light detection unit. The LED array and the light detection unit are disposed in the lamp body. The light driving unit receives at least one electric signal and then converts it to at least one current signal for driving the LED array to radiate at least one first light beam. The light detection unit converts at least one second light beam irradiating the lamp body into a detect signal.

### CROSS-REFERENCE TO RELATED APPLICATIONS

The entire contents of Taiwan Patent Application No. 099131030, filed on Sep. 14, 2010, from which this application claims priority, are incorporated herein by reference.

### BACKGROUND OF THE INVENTION

1. Field of the Invention

The present invention generally relates to a light emitting diode (LED) lamp and an optical communication networking system, and more particularly to an LED lamp and an optical communication networking system that are capable of concurrently providing illumination and communication.

2. Description of Related Art

A light emitting diode (LED) is a semiconductor device that is made of a light-emitting material comprised of group III-V elements, such as semiconductor compound gallium phosphate (GaP) or gallium arsenide (GaAs). The LED emits light via electron-hole recombination, which releases energy in the form of a photon. As the LED has fast response, small volume, low power consumption, low pollution, high reliability and high mass productivity, it has been extensively applied, for example, in large signboards, traffic lights, mobile phones, scanners and lighting devices.

Moreover, light communication products have become a mainstream due to the prosperity of communication industry and the speed demanded by the users. The LED may be used as a means for information communication and has been widely applied in the light communication system. Accordingy, the LED encompasses a wide range of applications from illumination to communication system. However, in current practice, the LED is put to use for the purpose of either illumination or communication but not both. Therefore, a need has arisen to make a significant breakthrough in making full use of the LED in both respects of illumination and communication.

### SUMMARY OF THE INVENTION

In view of the foregoing, it is an object of the embodiment of the present invention to provide a light-emitting diode (LED) lamp and a light communication networking system, which adopt an LED array to radiate a light beam of illumination and communication for the purpose of accomplishing both illumination and light communication.

According to one embodiment, an LED lamp includes a lamp body, an LED array, a light driving unit and a light detection unit. The LED array is disposed in the lamp body. The light driving unit is coupled to receive at least one electric signal, which is then converted to at least one current signal for driving the LED array to radiate at least one first light beam. The light detection unit is disposed in the lamp body and configured to convert at least one second light beam irradiating the lamp body into at least one detect signal.

According to another embodiment, a light communication networking system includes a first LED lamp and a second LED lamp. When the second LED lamp is disposed along a communication path of the first light beam, the second LED lamp converts the first light beam irradiating the second lamp body into a second detect signal via the second light detection unit, and radiates the second light beam via the second LED array.

### BRIEF DESCRIPTION OF THE DRAWINGS

FIG. 1 shows a circuit diagram illustrative of a light-emitting diode (LED) lamp according to one embodiment of the present invention;

FIG. 2 shows a cross-sectional view of an LED lamp according to one embodiment of the present invention;

FIG. 3 schematically shows an exemplary light communication networking system according to one embodiment of the present invention; and

FIG. 4 schematically shows another exemplary light communication networking system according to one embodiment of the present invention.

### DETAILED DESCRIPTION OF THE INVENTION

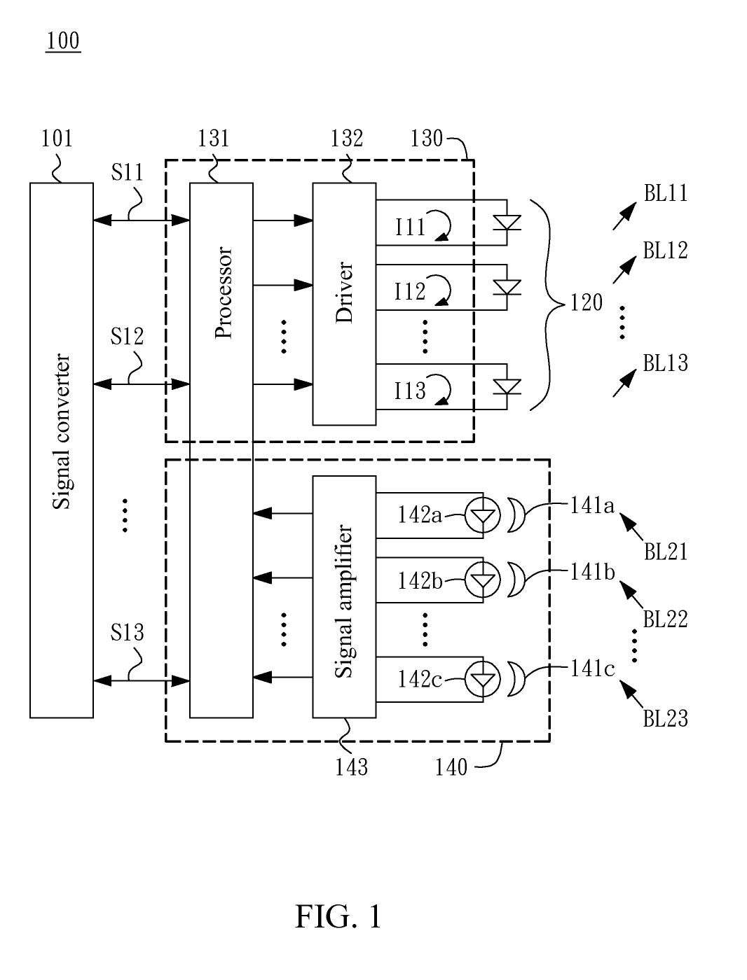

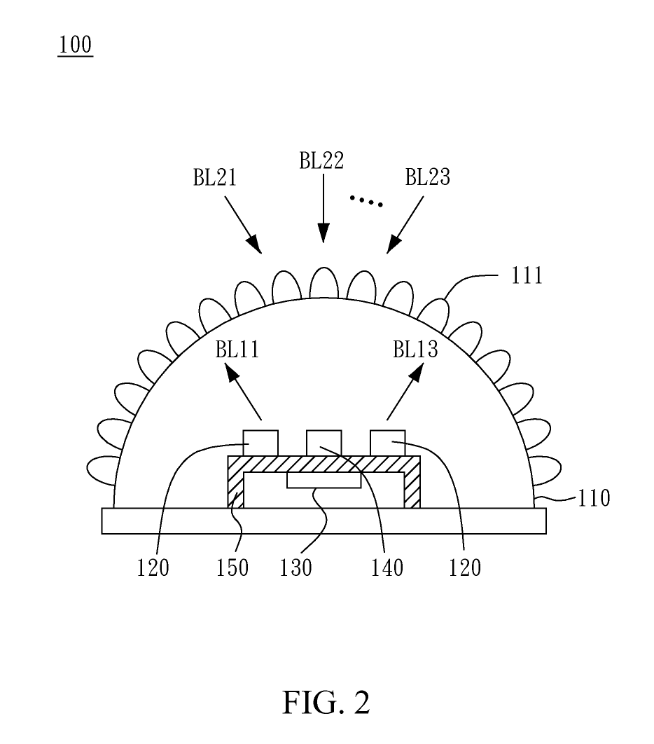

FIG. 1 shows a circuit diagram illustrative of a light-emitting diode (LED) lamp 100 according to one embodiment of the present invention, and FIG. 2 shows a cross-sectional view of the LED lamp 100 according to one embodiment of the present invention. The LED lamp 100 includes a lamp body 110, an LED array 120, a light driving unit 130 and a light detection unit 140. Specifically, the light driving unit 130 includes a processor 131 and a driver 132, and the light detection unit 140 includes at least one optical filter (e.g., optical filters 141a-141c), at least one light detector e.g., light detectors 142a-142c), a signal amplifier 143 and the processor 131. Generally speaking, the processor 131 may be shared between the light driving unit 130 and the light detection unit 140. Alternatively, the light driving unit 130 and the light detection unit 140 may have their respective processor 131.

In operation, the LED lamp 100 is adapted and electrically coupled to a signal converter 101. Accordingly, the processor 131 receives at least one interface-compliant electric signal (e.g., electric signals S11-S13) from the signal converter 101. In the specification, the electric signal may be a modulation signal or a signal of other forms. Moreover, the processor 131 may further process, for example, to adjust the gain of the electric signals S11-S13. The driver 132 then converts the adjusted electric signals S11-S13 to at least one current signal (e.g., current signals I11-I13), which drives the LED array 120 to radiate at least one first light beam (e.g., first light beams BL11-BL13).

In other words, the LED lamp 100 converts the electric signals S11-S13 to the current signals I11-I13 via the light driving unit 130. Accordingly, the LED array 120 generates the first light beams BL11-BL13 according to the current signals I11-I13 respectively, and then radiates the first light beams BL11-BL13 out of the lamp body 110.

On the other hand, as second light beams BL21-BL23 external to the lamp body 110 irradiate the LED lamp 100, the optical filters 141a-141c disposed along a communication path selectively pass the second light beams BL21-BL23. The light detectors 142a-142c respectively corresponding to the optical filters 141a-141c are used to convert the second light beams BL21-1BL23 coming from the optical filter 141a-141c into electric signals, thereby outputting at least one detect signal. Moreover, the signal amplifier 143 may be used to amplify the at least one detect signal. Further, the processor 131 may be used to process the detect signal.

In other words, the LED lamp 100 receives the second light beams BL21-BL23 external to the lamp body 110 via the light detecting unit 140, and then converts the second light beams BL21-BL23 to the electric signals readable by an electronic device. In the embodiment, the light detectors 142a-142c may be made of photoresistors or photo transistors. It is appreciated that other suitable types of the light detector may be selected, by a person skilled in the pertinent field, according to a specific application.

It is noted that the LED array 120, the light driving unit 130 and the light detection unit 14 may be disposed in the lamp body 100. Moreover, the lamp body 100 includes an optical device 111, which may alter a refraction angle of the first light beams BL11-BL13 and the second light beams BL21-BL23 crossing the lamp body 110. Accordingly, the optical device 111 may expand a radiating range of the first light beams BL11-BL13 out of the lamp body 110, and may concentrate an irradiating range of the second light beams BL21-BL23 on the light detectors 140.

Furthermore, the LED lamp 100 may further include a carrier 150 (such as a circuit board), which may be disposed at a central bottom of the lamp body 110 as shown in FIG. 2. In the embodiment, the LED array 120 and the light detection unit 140 are disposed on a top surface of the carrier 150, and the light driving unit 130 is disposed at a bottom surface of the carrier 150. Moreover, the LED array 120 surrounds the light detection unit 140, accompanied by the optical device 111 of the lamp body 100, to obtain proper communication. The relationship among the LED array 120, the light detection unit 140 and the light driving unit 130, and the relationship between the LED array 120 and the light detection unit 140 may be adjusted according to specific applications.

In the embodiment, the wavelength of the first light beams BL11-BL13 is different from the wavelength of the second light beams BL21-BL23 such that they may be concurrently operated in distinct wave bands to reduce interference between them. Moreover, the electric signals S11-S13 may be video signals from a mobile television broadcasting network, broadcast signals from a digital broadcasting network, network signals from the Internet or frequency/amplitude modulated signals. For example, the mobile television broadcasting network may be a one-way broadcasting network compliant with Digital Video Broadcasting-Handheld (DVB-H)/DVB for IP datacasting (DVB-IPDC).

According to the foregoing discussion, the present embodiment uses the current signals I11-I13 derived from the electric signals S11-S13 to directly drive the LED array 120. Accordingly, the first light beams BL11-BL13 radiating from the LED array 120 provides not only illumination but also information carried in the electric signals S11-S13. Moreover, the LED lamp 100 accompanied by the light detection unit 140 possesses light communication capability. Further, the LED lamp 100 may further enhance the illumination and communication via the optical device 111 of the lamp body 110.

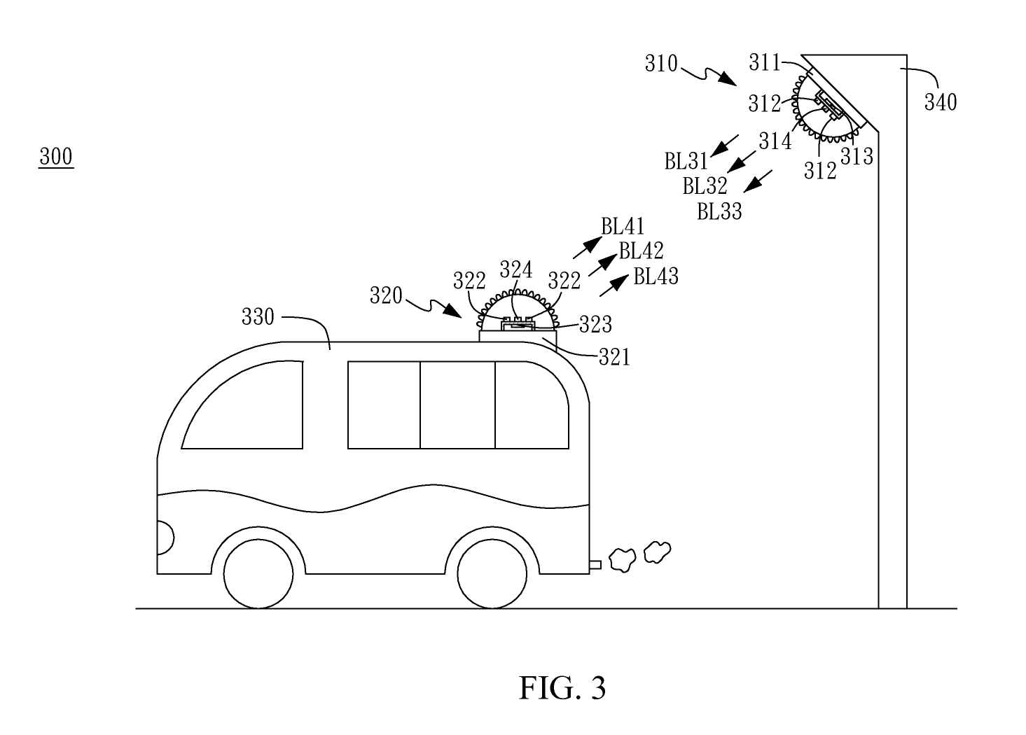

According to one aspect of the present invention, the light communication capability of the LED lamp 100 may be applied in a light communication networking system. FIG. 3 schematically shows an exemplary light communication networking system 300 according to one embodiment of the present invention. The light communication networking system 300 includes a first LED lamp 310 disposed in a hardware facility 340; and a second LED lamp 320 disposed in a hardware device such as a moving public transportation vehicle 330. Specifically, the first LED lamp 310 and the second LED lamp 320 have the same structure and circuit as shown in the LED lamp 100 of FIG. 1 and FIG. 2.

As shown in FIG. 3, the first LED lamp 310 includes a first lamp body 311, a first LED array 312, a first light driving unit 313 and a first light detection unit 314. The second LED lamp 320 includes a second lamp body 321, a second LED array 322, a second light driving unit 323 and a second light detection unit 324. The first LED lamp 310 includes a first carrier disposed at a central bottom of the first lamp body 311, wherein the first LED array 312 and the first light detection unit 314 are disposed on a top surface of the first carrier, and the first light driving unit 313 is disposed on a bottom surface of the first carrier. The second LED lamp 320 includes a second carrier disposed at a central bottom of the second lamp body 321, wherein the second LED array 322 and the second light detection unit 324 are disposed on a top surface of the second carrier, and the second light driving unit 323 is disposed on a bottom surface of the second carrier. The first LED array 312, the first light detection unit 314, the first light driving unit 313, the second LED array 322, the second light detection unit 324 and the second light driving unit 323 may be adaptively disposed according to specific applications. The first lamp body 311 includes a first optical device for expanding a radiating range of the first light beams out of the first lamp body 311, and concentrating an irradiating range of the second light beams on the first light detection unit 314 of the first LED lamp 310. The second lamp body 321 includes a second optical device configured to change the refraction angle of the first and second light beams crossing the second lamp body 321 for expanding a radiating range of the second light beams out of the second lamp body 321, and concentrating an irradiating range of the first light beams on the second light detection unit 324 of the second LED lamp 320. It is assumed that the first LED lamp 310 and the second LED lamp 320 have the same structure as the LED lamp 100, and the descriptions of the arrangement, the composing elements (e.g., the composing elements of the first light driving unit 313, the second light driving unit 323, the first light detection unit 314 and the second light detection unit 324) and the operation of the first LED lamp 310 and the second LED lamp 320 are thus omitted for brevity. The signal communication performed by the public transportation vehicle 330 via the first LED lamp 310 and the second LED lamp 320 will be described below.

In the embodiment, the first LED lamp 310 is fixed on the hardware facility 340, and is adaptively connected to a signal converter (not shown) of the hardware facility 340 for receiving at least one first electric signal. Moreover, the first LED lamp 310 may radiate at least one first light beam BL31-BL33 out of the first lamp body 311 via the first LED array 312 disposed in the first LED lamp 310.

With respect to the public transportation vehicle 330, the first light beams BL31-BL33 provide not only illumination but also information carried in the first electric signal. Accordingly, when the public transportation vehicle 330 moves along a communication path of the first light beams BL31-BL33, it converts the first light beams BL31-BL33 into a second detect signal via the second light detection unit 324, such that the information of the first electric signal may thus be read out.

On the other hand, the second LED lamp 320 is adaptively connected to a signal converter (not shown) of the public transportation vehicle 330 for receiving at least one second electric signal. Moreover, the public transportation vehicle 330 may radiate at least one second light beam BL41-BL43 out of the second lamp body 321 via the second LED array 322 disposed in the second LED lamp 320. Accordingly, the first LED lamp 310 may convert the second light beams BL41-BL43 into a first detect signal via the first light detection unit 314, such that the information of the second electric signal may thus be read out.

The first LED array 312 of the first LED lamp 310 and the second light detection unit 324 of the second LED lamp 320 operate at the same wave band. Moreover, the first light detection unit 314 of the first LED lamp 310 and the second LED array 322 of the second LED lamp 320 operate at the same wave band. Accordingly, the first LED lamp 310 and the second LED lamp 320 may communicate with each other.

With respect to the first LED lamp 310, the first optical device of the first LED lamp 310 may expand a radiating range of the first light beams BL31-BL33 out of the first lamp body 311, and concentrate an irradiating range of the second light beams BL41-BL43 on the first light detection unit 314. On the other hand, with respect to the second LED lamp 320, the second optical device of the second LED lamp 321 may expand a radiating range of the second light beams BL41-BL43 out of the second lamp body 321, and concentrate an irradiating range of the first light beams BL31-BL33 on the second light detection unit 324.

Accordingly, when the hardware device of the light communication networking system 300 is a public transportation vehicle 330, the light communication networking system 300 can timely provide traffic information, and act as a monitoring system for providing dynamic information, transfer information and arriving time about the public transportation vehicle.

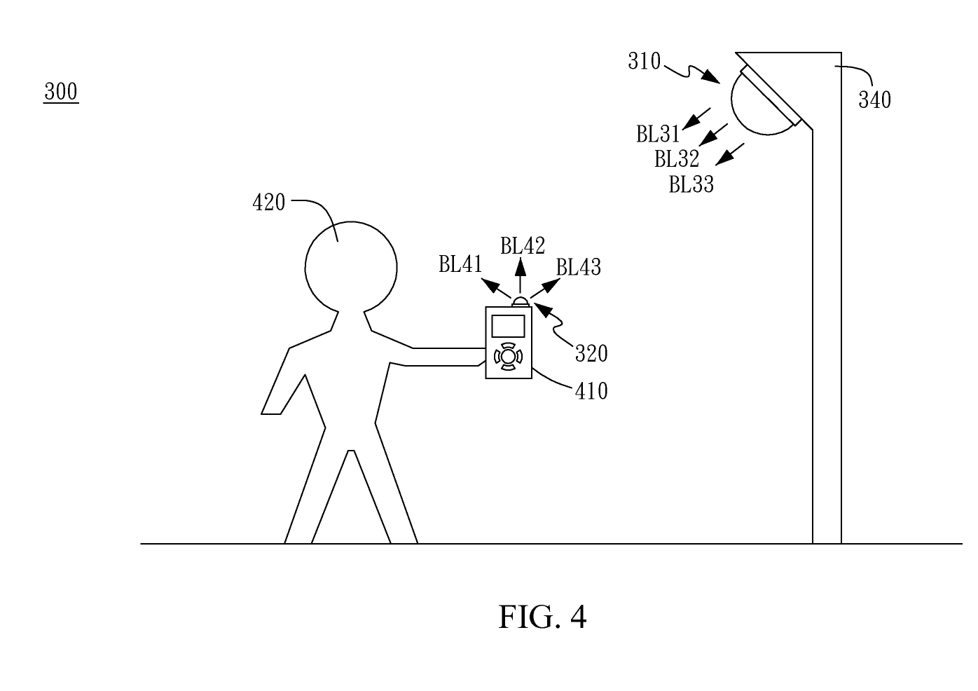

FIG. 4 schematically shows another exemplary light communication networking system 300 according to one embodiment of the present invention. For better understanding the embodiment, the first LED lamp 310 and the second LED lamp 320 are shown in a simplified form. As shown in FIG. 4, the hardware device of the light communication networking system 300 may be a mobile device 410 to be conveniently held by a user 420, and can be moved by the user 420 along a communication path of the first light beams BL31-BL33. Accordingly, the mobile device 410 may receive the information carried in the first light beams BL31-BL33 via the second LED lamp 320, wherein the information may be displayed or played for the user 420.

On the other hand, the user 420 may edit corresponding information in the mobile device 410, and then send the second light beams BL41-BL43 carrying the edited information via the second LED lamp 320. Further, the first LED lamp 310 may receive and read the information carried in the second light beams BL41-BL43, thereby achieving two-way communication.

When the hardware device of the light communication networking system 300 is a mobile device 410, the light communication networking system 300 may be applied in a museum, an art gallery or an information exhibition to implement a narration tool. For example, when the light communication networking system 300 is applied in the museum, the first LED lamp 310 may be disposed near a specific object to be displayed to transmit information about the specific object. On the other hand, a person interested in the specific object may move to the illumination range of the first LED lamp 310, and the second LED lamp 320 in the mobile device 410 may then receive the information, about the specific object.

Although the first LED lamp 310 is fixed on the hardware facility 340 in the light communication networking system 300 shown in FIG. 3 and FIG. 4, it is appreciated by a person skilled in the pertinent art that the first LED lamp 310 may be alternatively disposed in another hardware device (e.g,, a mobile device or a public transportation vehicle) in another embodiment, wherein the detailed operation is omitted here and may be referred to the embodiments discussed above. Although the light communication has been exemplified between the public transportation 330 and the hardware facility 340 (FIG. 3) or between the mobile device 410 and the hardware facility 340 (FIG. 4), however, the present invention may be adapted to other light communication, for example, between the public transportation vehicle 330 and the public transportation vehicle 330, between the mobile device 410 and the mobile device 410, between the public transportation vehicle 330 and the mobile device 410, or between any two objects equipped with the LED lamps 310/340.

For the foregoing discussions, the present invention utilizes the LED array for radiating the first light beams capable of both illumination and communication, and the light detection unit for receiving the second light beams irradiating the lamp body. Moreover, the lamp body uses an optical device for reducing interference between the first light beams and the second light beams and for enhancing radiating range. Accordingly, the LED lamp according to the present invention not only provides the illumination and the communication, but also enhances the performance of the illumination and the communication.

Although specific embodiments have been illustrated and described, it will be appreciated by those skilled in the art that various modifications may be made without departing from the scope of the present invention, which is intended to be limited solely by the appended claims.

What is claimed is:

1. A light emitting diode (LED) lamp, comprising:
a lamp body;
an LED array disposed in the lamp body;
a light driving unit coupled to receive at least one electric signal, which is then converted to at least one current signal for driving the LED array to radiate at least one first light beam; and
a light detection unit disposed in the lamp body and configured to convert at least one second light beam irradiating the lamp body into at least one detect signal.

2. The LED lamp of claim 1, further comprising:
a carrier disposed at a central bottom of the lamp body, wherein the LED array, the light detection unit and the light driving unit are disposed on a surface of the carrier.

3. The LED lamp of claim 1, wherein the lamp body comprises an optical device for changing a refractive angle of the first light beam and the second light beam crossing the lamp body, thereby expanding a radiating range of the first light beam and concentrating an irradiating range of the second light beam on the light detection unit.

4. The LED lamp of claim 1, wherein the light driving unit comprises:
a processor coupled to receive and process the electric signal; and
a driver configured to convert the processed electric signal into the current signal for driving the LED array.

5. The LED lamp of claim 1, wherein the light detection unit comprises:
at least one optical filter disposed along a communication path of the second light beam for selectively passing the second light beam; and
at least one light detector corresponding to the optical filter for converting the second light beam to output the detect signal.

6. A light communication networking system, comprising:
a first LED lamp, comprising:
a first lamp body;
a first LED array disposed in the first lamp body;
a first light driving unit coupled to receive at least one first electric signal, which is then converted to at least one first current signal for driving the first LED array to radiate at least one first light beam; and
a first light detection unit disposed in the first lamp body and configured to convert at least one second light beam irradiating the first lamp body into at least one first detect signal; and
a second LED lamp, comprising:
a second lamp body;
a second LED array disposed in the second lamp body;
a second light driving unit coupled to receive at least one second electric signal, which is then converted to at least one second current signal for driving the second LED array to radiate the second light beam; and
a second light detection unit disposed in the second lamp body;
when the second LED lamp is disposed along a communication path of the first light beam, the second LED lamp converts the first light beam irradiating the second lamp body into a second detect signal via the second light detection unit, and radiates the second light beam via the second LED array.

7. The system of claim 6, further comprising a hardware device, in which the second LED lamp is disposed.

8. The system of claim 7, wherein the hardware device comprises a public transportation vehicle or a mobile device.

9. The system of claim 6, wherein the first LED lamp further comprises a first carrier disposed at a central bottom of the first lamp body, wherein the first LED array, the first light detection unit and the first light driving unit are disposed on a surface of the first carrier; and the second LED lamp further comprises a second carrier disposed at a central bottom of the second lamp body, wherein the second LED array, the second light detection unit and the second light driving unit are disposed on a surface of the second carrier.

10. The system of claim 6, wherein the first lamp body comprises a first optical device for expanding a radiating range of the first light beam out of the first lamp body and concentrating an irradiating range of the second light beam on the first light detection unit of the first LED lamp; and the second lamp body comprises a second optical device for changing a refractive angle of the first light beam and the second light beam crossing the second lamp body, thereby expanding a radiating range of the second light beam out of the second lamp body and concentrating an irradiating range of the second light beam on the second light detection unit of the second LED lamp.

11. The system of claim 6, wherein the first light driving unit or the second light driving unit comprises:
a processor coupled to receive the first or second electric signal; and
a driver configured to convert the processed first or second electric signal into the first or second current signal for driving the first or second LED array.

12. The system of claim 6, wherein the first light detection unit or the second light detection unit comprises:
at least one optical filter disposed along a communication path of the first or second light beam for selectively passing the first or second light beam; and
at least one light detector corresponding to the optical filter for converting the first or second light beam to output the first or second detect signal.
